(19) United States
(12) Patent Application Publication
(10) Pub. No.: US 2016/0004287 A1
(43) Pub. Date: Jan. 7, 2016

(54) PORTABLE ELECTRONIC DEVICE AND POWER MANAGEMENT METHOD THEREOF

(71) Applicant: Wistron Corp., New Taipei City (TW)

(72) Inventor: Jun Xin QIU, New Taipei City (TW)

(21) Appl. No.: 14/662,016

(22) Filed: Mar. 18, 2015

(30) Foreign Application Priority Data
Jul. 4, 2014 (CN) 201410317079.0

(51) Int. Cl. G06F 1/26; H01H 13/7065; H02J 7/00; H01R 24/60

(52) U.S. Cl. CPC G06F 1/266; H01R 24/60; H01H 13/7065; H02J 7/0052; H02J 7/0045; H01R 2107/00

(57) ABSTRACT

A portable electronic device with OTG functionality is provided. The portable electronic device includes a USB connector, a processor and a power management module. When the USB connector is coupled to a USB device, the processor provides a switching signal according to identification data of the USB device. According to the switching signal, the power management module selectively provides a first power signal to the USB device, so as to power the USB device, or receives a second power signal from the USB device for charging a battery. The USB connector has an identification pin coupled to a ground.

### CROSS REFERENCE TO RELATED APPLICATIONS

This Application claims priority of China Patent Application No. 201410317079.0, filed on Jul. 4, 2014, the entirety of which is incorporated by reference herein.

### BACKGROUND OF THE INVENTION

1. Field of the Invention

The invention relates to a portable electronic device, and more particularly to a portable electronic device with on the go (OTG) functionality.

2. Description of the Related Art

Universal Serial Bus (USB) is a serial bus standard for connection of an external apparatus, which provides hot plug, plug-and-play and other related functions. For example, the USB 2.0 standard provides three transfer rates: low-speed; full-speed; and high-speed transfer rates, which support: 1.5 Mbps; 12 Mbps; and 480 Mbps data rates, respectively. Therefore, for current intelligent electronic products (such as mobile phones, tablet PCs, etc.), the USB interfaces are common.

With the popularity of intelligent electronic products, more and more intelligent electronic product have a USB interface with on the go (OTG) functionality, which can provide host and peripheral options through a single USB connector. The USB OTG functionality is an enhancement in USB 2.0 standard, which is specifically used in the portable devices that need lower power consumption and smaller connectors. The USB OTG functionality can provide the interconnection applications in a peer-to-peer method. The OTG functionality can use a Host Negotiation Protocol (HNP) to determine the master-slave relationship of two interconnected devices by comparing each other, so as to become a dual-role device with the master and slave functionality, such as an electronic device disclosed in Taiwan Patent Application No. TW200540637.

### BRIEF SUMMARY OF THE INVENTION

Portable electronic devices and power management method thereof are provided. An embodiment of a portable electronic device is provided. The portable electronic device comprises a first universal serial bus (USB) connector, a processor, and a power management module. The processor provides a switching signal according to identification data of a USB device when the first USB connector is coupled to the USB device. The power management module selectively provides a first power signal to the USB device, so as to power the USB device, or it receives a second power signal from the USB device for charging, according to the switching signal. The first USB connector has a first identification pin coupled to a ground.

Furthermore, an embodiment of a power management method for a portable electronic device is provided. A universal serial bus (USB) device is emulated upon detection that the USB device is coupled to a first USB connector of the portable electronic device. Identification data of the USB device is obtained via the first USB connector after the USB device is emulated. A switching signal is provided according to the identification data. According to the switching signal, a first power signal is provided to power the USB device, or a second power signal is received from the USB device for charging via the first USB connector. The first USB connector has a first identification pin coupled to a ground.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a USB system with OTG functionality according to an embodiment of the invention;

FIG. 2 shows a USB system with OTG functionality according to another embodiment of the invention; and

FIG. 3 shows a power management method for a portable electronic device with OTG functionality according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

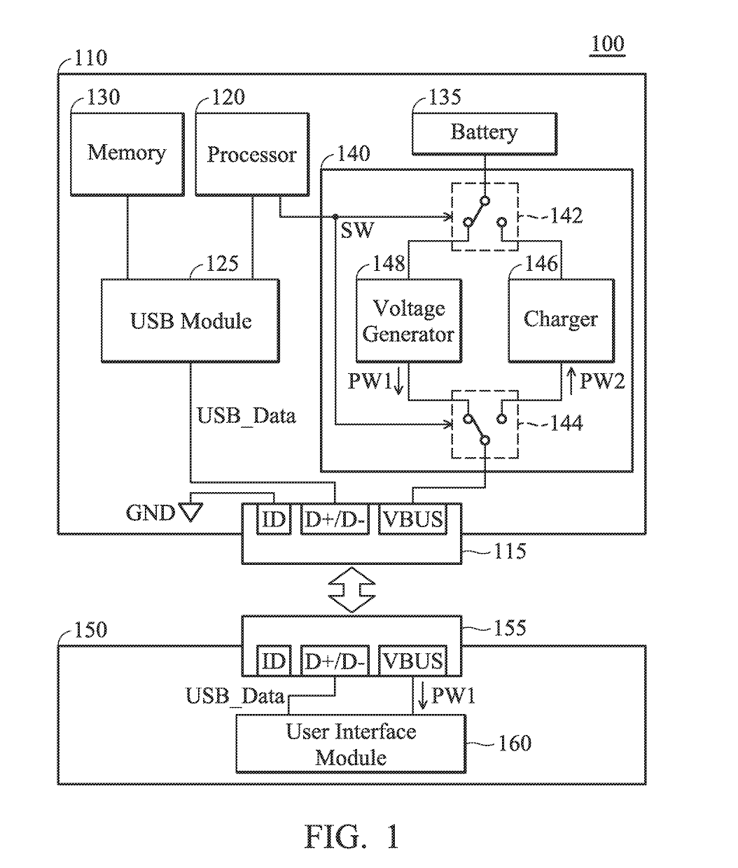

FIG. 1 shows a Universal Serial Bus (USB) system 100 with on the go (OTG) functionality according to an embodiment of the invention. The USB system 100 comprises a portable electronic device 110 and a USB device 150. The portable electronic device 110 comprises a USB connector 115, a processor 120, a USB module 125, a memory 130, a battery 135 and a power management module 140. In the embodiment, the portable electronic device 110 may be a smart phone or a tablet PC, and so on. The USB connector 115 is a receptacle which conforms to a mini-USB or micro-USB standard. In one embodiment, the USB connector 115 is a connector that supports USB 2.0 standard, wherein the USB connector 115 comprises the data pins D+and D−, a power pin VBUS, a power pin VSS (not shown) and an identification pin ID, wherein the identification pin ID is coupled to a ground GND. The USB module 125 is coupled between the data pins D+and D− of the USB connector 115 and the processor 120 for receiving or providing the USB data (USB_Data). The power management module 140 is coupled between the power pin VBUS of the USB connector 115 and the processor 120, and the power management module 140 can selectively provide a power signal (PW1) to the power pin VBUS or receive a power signal (PW2) from the power pin VBUS. In the embodiment, the power signal (PW1) is compatible with a VBUS signal of a USB standard, i.e. a signal having 5 volts and up to 500 mA. The power management module 140 comprises the switching units 142 and 144, a charger 146 and a voltage generator 148. The switching unit 142 selectively couples the battery 135 to the charger 146 or the voltage generator 148 according to a switching signal (SW) from the processor 120. Furthermore, the switching unit 144 also selectively couples the power pin VBUS of the USB connector 115 to the charger 146 or the voltage generator 148 according to the switching signal (SW) from the processor 120. In FIG. 1, the USB device 150 is a traditional user input device, such as a keyboard, a mouse, or a touch device. The USB device 150 comprises a USB connector 155 and a user interface module 160. The USB connector 155 is a plug that conforms to the mini-USB or micro-USB standard. In one embodiment, the USB connector 155 is a connector that supports the USB 2.0 standard, and the USB connector 155 comprises the data pins D+and D−, a power pin VBUS, a power pin VSS (not shown) and an identification pin ID, wherein the identification pin ID is floating. In the portable electronic device 110 of FIG. 1, when detecting that the USB connector 155 of the USB device 150 is coupled to the USB connector 115 via a USB connection line (not shown), the processor 120 will control the power management module 140 to provide the power signal (PW1), so as to power the USB device 150. For example, the processor 120 provides the switching signal (SW) with a first logic level to the switching units 142 and 144, so that the voltage generator 148 is coupled to the battery 135 and the USB connector 115. Thus, the voltage generator 148 generates the power signal (PW1) to the power pin VBUS of the USB connector 115 according to the voltage of the battery 135, so as to power the USB device 150. Next, the processor 120 controls the USB module 125 to perform enumeration and configuration for the USB device 150. After the enumeration and configuration of the USB device 150 are completed, the processor 120 obtains identification data (ID_Data) of the USB device 150 via the USB connector 115 and the USB module 125, wherein the identification data (ID_Data) comprises a vendor identification (Vendor ID, VID) code and a product identification (Product ID, PID) code. Next, the processor 120 determines the type of USB device 150 being used according to the identification data (ID_Data). In the embodiment, the processor 120 will determine that the USB device 150 is a user input device. Thus, the processor 120 continues providing the switching signal (SW) with a first logic level to the switching units 142 and 144, so as to power the USB device 150.

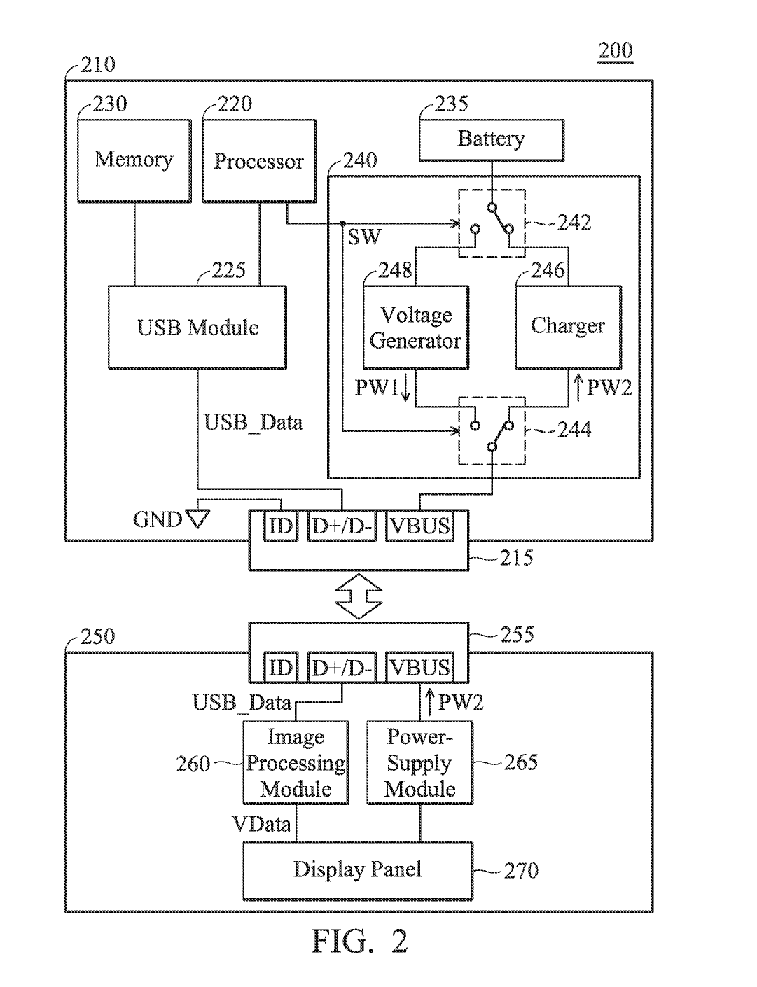

FIG. 2 shows a USB system 200 with OTG functionality according to another embodiment of the invention. The USB system 200 comprises a portable electronic device 210 and a USB device 250. As described above, the portable electronic device 210 comprises a USB connector 215, a processor 220, a USB module 225, a memory 230, a battery 235 and a power management module 240. In the embodiment, the portable electronic device 210 may be a smart phone or a tablet PC, for example. The USB connector 215 is a receptacle which conforms to a mini-USB or micro-USB standard. In one embodiment, the USB connector 215 is a connector that supports USB 2.0 standard, wherein the USB connector 215 comprises the data pins D+and D−, a power pin VBUS, a power pin VSS (not shown) and an identification pin ID, wherein the identification pin ID is coupled to the ground GND. In FIG. 2, the USB device 250 is a hybrid display device. The USB device 250 comprises a USB connector 255, an image processing module 260, a power-supply module 265 and a display panel 270. The USB connector 255 is a plug that conforms to a mini-USB or micro-USB standard. In one embodiment, the USB connector 255 is a connector that supplies USB 2.0 standard, wherein the USB connector 255 comprises the data pins D+and D−, a power pin VBUS, a power pin VSS (not shown) and an identification pin ID, wherein the identification pin ID is floating. The power-supply module 265 may provide various levels of operating power to each module and circuit in the USB device 250. In other words, the USB device 250 can be self-powered. In the portable electronic device 210 of FIG. 2, when detecting that the USB connector 255 of the USB device 250 is coupled to the USB connector 215 via a USB connection line (not shown), the processor 220 controls the USB module 225 to perform enumeration and configuration for the USB device 250. As described above, in one embodiment, the processor 220 controls the power management module 240 to provide a power signal (PW1) to the USB device 250. For example, the processor 220 can provide a switching signal (SW) with a first logic level to the switching units 242 and 244, so that the voltage generator 248 can generate the power signal (PW1) to the power pin VBUS of the USB connector 215 according to a battery voltage of the battery 235. Due to capability of the USB device 250 to be self-powered, the power-supply module 265 will not receive the power signal (PW1) from the power management module 240. Next, after the enumeration and configuration of the USB device 250 are completed, the processor 220 obtains identification data (ID_Data) of the USB device 250 via the USB connector 215 and the USB module 225, wherein the identification data (ID_Data) comprises a VID code and a PID code. Next, the processor 220 determines a type of the USB device 250 according to the identification data (ID_Data). In the embodiment, the processor 220 will determine that the USB device 250 is a display device. Next, the processor 220 provides the switching signal (SW) with a second logic level to the switching units 242 and 244, so that the charger 248 is coupled to the battery 235 and the USB connector 215. In the embodiment, the second logic level is complementary to the first logic level. Next, the processor 220 controls the USB module 225 to convert the video data or multimedia data stored in the memory 230 into the USB data (USB_Data), and provides the USB data (USB_Data) to the USB device 250 via the USB connector 215. Next, in the USB device 250, the image processing module 260 obtains the USB data (USB_Data) via the USB connector 255. In one embodiment, the image processing module 260 is a graphics chip that supports a USB standard. Next, the image processing module 260 converts the USB data (USB_Data) into the video data (VData), and provides the video data (VData) to the display panel 270 for displaying the video data (VData). Simultaneously, the image processing module 260 controls the power-supply module 265 to provide a power signal (PW2) to the USB connector 255, so as to charge the portable electronic device 210. Next, in the portable electronic device 210, the charger 246 charges the battery 235 according to the power signal (PW2) from the power pin VBUS of the USB connector 215. Thus, the standby time of the portable electronic device 210 is increased.

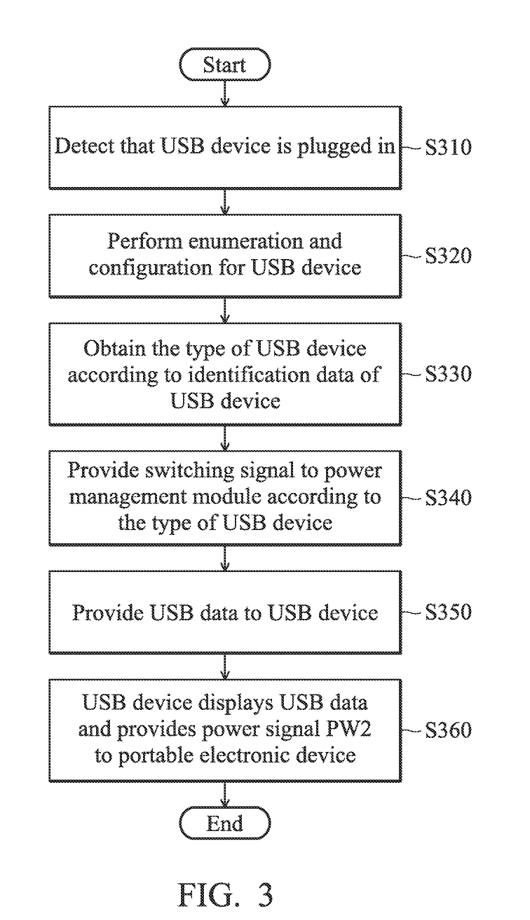

FIG. 3 shows a power management method for a portable electronic device with OTG functionality (e.g. 110 of FIG. 1 or 210 of FIG. 2) according to another embodiment of the invention. Referring to FIG. 2 and FIG. 3 together, first, in step S310, the processor 220 detects that the USB device 250 is plugged in (or coupled to) the portable electronic device 210.

Next, in step S320, the portable electronic device 210 performs enumeration and configuration for the USB device 250. Next, in step S330, the portable electronic device 210 obtains the identification data (ID_Data) from the USB device 250, and identifies the type of the USB device 250 according to the identification data (ID_Data), wherein the identification data (ID_Data) comprises the VID code and the PID code. Next, in step S340, the processor 220 provides the switching signal (SW) to control the switching units 242 and 244 according to the type of USB device 250, so that the charger 246 can be coupled to the battery 235 and the USB connector 215. Next, in step S350, the portable electronic device 210 provides the USB data (USB_Data) to the USB device 250. Next, in step S360, the USB device 250 converts the USB data (USB_Data) into the video data (VData), and displays the video data (VData). Simultaneously, the USB device 250 provides the power signal (PW2) to the portable electronic device 210, so that the charger 246 can charge the battery 235 according to the power signal (PW2).

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A portable electronic device, comprising:
a first universal serial bus (USB) connector;
a processor, providing a switching signal according to an identification data of a USB device when the first USB connector is coupled to the USB device; and
a power management module, selectively providing a first power signal to the USB device, so as to power the USB device, or receiving a second power signal from the USB device for charging a battery according to the switching signal,
wherein the first USB connector has a first identification pin coupled to a ground.

2. The portable electronic device as claimed in claim 1, wherein the identification data comprises a vendor identification code and a product identification code.

3. The portable electronic device as claimed in claim 2, further comprising:
a USB module coupled between the first USB connector and the processor, obtaining the identification data from the USB device when the first USB connector is coupled to the USB device, and providing the identification data to the processor,
wherein before the identification data is obtained, the USB module enumerates the USB device via the first USB connector.

4. The portable electronic device as claimed in claim 3, wherein when the processor identifies that the USB device is a user input device according to the vendor identification code and the product identification code, the processor provides the switching signal to the power management module, so as to provide the first power signal to the USB device via the first USB connector.

5. The portable electronic device as claimed in claim 4, wherein the first power signal is compatible with a VBUS signal of a USB standard.

6. The portable electronic device as claimed in claim 4, wherein the user input device is a keyboard, a mouse or a touch device.

7. The portable electronic device as claimed in claim 3, wherein when the processor identifies that the USB device is a display device according to the vendor identification code and the product identification code, the processor provides the switching signal to the power management module, so as to receive the second power signal from the USB device via the first USB connector.

8. The portable electronic device as claimed in claim 7, further comprising:
a battery; and
a memory, storing a video data;
wherein the power management module comprises:
a voltage generator, providing the first power signal according to a battery voltage of the battery; and
a charger, charging the battery according to the second power signal from the USB device.

9. The portable electronic device as claimed in claim 8, wherein when the processor identifies that the USB device is the display device, the USB module provides the video data stored in the memory to the USB device via the first USB connector.

10. The portable electronic device as claimed in claim 9, wherein the power management module further comprises:
a first switching unit, selectively coupling the voltage generator or the charger to the battery according to the switching signal; and
a second switching unit, selectively coupling the voltage generator or the charger to the first USB connector according to the switching signal.

11. The portable electronic device as claimed in claim 10, wherein the USB device comprises:
a second USB connector coupled to the first USB connector, obtaining the video data and providing the second power signal;
a power-supply module, generating the second power signal after the video data is obtained;
a display panel; and
an image processing module, displaying the video data on the display panel,
wherein the second USB connector has a second identification pin that is floating.

12. A power management method for a portable electronic device, comprising:
emulating a universal serial bus (USB) device when detecting that the USB device is coupled to a first USB connector of the portable electronic device;
obtaining an identification data of the USB device via the first USB connector after the USB device is emulated;
providing a switching signal according to the identification data; and
according to the switching signal, selectively providing a first power signal to power the USB device via the first USB connector, or receiving a second power signal from the USB device via the first USB connector for charging a battery;
wherein the first USB connector has a first identification pin coupled to a ground.

13. The power management method as claimed in claim 12, wherein the identification data comprises a vendor identification code and a product identification code.

14. The power management method as claimed in claim 13, wherein the step of selectively providing the first power signal via the first USB connector or receiving the second power signal via the USB device further comprises:
providing the switching signal to a power management module of the portable electronic device when identifying that the USB device is a user input device according to the vendor identification code and the product identification code, so as to provide the first power signal to the USB device via the first USB connector.

15. The power management method as claimed in claim 14, wherein the first power signal is compatible with a VBUS signal of a USB standard.

16. The power management method as claimed in claim 14, wherein the user input device is a keyboard, a mouse or a touch device.

17. The power management method as claimed in claim 13, wherein the step of selectively providing the first power signal via the first USB connector or receiving the second power signal via the USB device further comprises:
providing the switching signal to the power management module when identifying that the USB device is a display device according to the vendor identification code and the product identification code, so as to receive the second power signal from the USB device via the first USB connector.

18. The power management method as claimed in claim 17, wherein the portable electronic device further comprises:
a battery; and
a memory, storing a video data;
wherein the power management module comprises:
a voltage generator, providing the first power signal according to a battery voltage of the battery; and
a charger, charging the battery according to the second power signal from the USB device.

19. The power management method as claimed in claim 18, further comprising:
providing the video data stored in the memory to the USB device via the first USB connector when identifying that the USB device is the display device.

20. The power management method as claimed in claim 19, wherein the USB device comprises:
a second USB connector coupled to the first USB connector, obtaining the video data and providing the second power signal;
a power-supply module, generating the second power signal after the video data is obtained;
a display panel; and
an image processing module, displaying the video data on the display panel,
wherein the second USB connector has a second identification pin that is floating.
